(19) United States
(12) Patent Application Publication
(10) Pub. No.: US 2020/0124786 A1
(43) Pub. Date: Apr. 23, 2020

(54) DISPLAY DEVICES USING LED BACKLIGHT UNITS AND LED PACKAGES FOR THE BACKLIGHT UNITS

(71) Applicant: LUMENS CO., LTD., Yongin-si (KR)

(72) Inventors: Minyoung Heo, Yongin-si (KR); Yungeon Cho, Yongin-si (KR); Byungjoo Ji, Yongin-si (KR); Kyungho Kang, Yongin-si (KR); Ilyeul Seo, Yongin-si (KR)

(73) Assignee: LUMENS CO., LTD., Yongin-si (KR)

(21) Appl. No.: 16/582,901

(22) Filed: Sep. 25, 2019

(30) Foreign Application Priority Data
Oct. 18, 2018 (KR) 10-2018-0124742
Aug. 27, 2019 (KR) 10-2019-0105119

(51) Int. Cl. F21V 8/00; G02F 1/1335; H05B 33/08

(52) U.S. Cl. CPC G02B 6/0073; G02B 6/005; H05B 33/0857; G02F 1/133514

(57) ABSTRACT

A display device is disclosed. The display device includes: a liquid crystal panel including color filters; and a backlight unit including a light guide plate arranged in rear of the liquid crystal panel and a bar-type LED module arranged at one side of the light guide plate to supply backlight to the one side of the light guide plate. The bar-type LED module includes: a substrate elongated along the one side of the light guide plate; a plurality of LED packages arrayed on the substrate and each including a first LED emitting first white light and a second LED emitting second white light and separated from the first LED by a partition wall; a first wiring connecting the first LEDs of the plurality of LED packages in series; a second wiring connecting the second LEDs of the plurality of LED packages in series; and a control unit controlling the ratio of a current applied to the first LEDs and a current applied to the second LEDs to adjust the color coordinates of backlight produced by the first white light and the second white light. The control unit adjusts the color coordinates of the backlight along a straight line connecting the color coordinates of the first white light and the color coordinates of the second white light.

### BACKGROUND OF THE INVENTION

### 1. Field of the Invention

The present invention relates to LED packages for LED backlight units and display devices using the LED backlight units.

### 2. Description of the Related Art

Liquid crystal display (LCD) TVs are well known as display devices using backlight units. A typical LCD TV includes a liquid crystal panel with color filters. The liquid crystal panel is non-emissive and only adjusts the transmittance of incident light. Thus, the LCD TV further includes a backlight unit that provides light to the liquid crystal panel. Various types of backlight units are available in LCD TVs. At present, LED backlight units including white LEDs with specific color temperatures are mainly used in LCD TVs.

Current LCD TVs are designed to select various viewing modes such as movie mode or sports mode. For mode selection, color coordinates need to be adjusted. Current LCD TVs use RGB color filters provided in liquid crystal panels to adjust color coordinates because the color and temperature of light emitted from white LEDs of backlight units are determined.

The adjustment of color coordinates using only color filters leads to low brightness, resulting in poor overall efficiency. For example, R filters and G filters are used to achieve white light emission with a dominant blue component but they block backlight, thereby deteriorating the brightness of display light. In other words, since the color temperature of light emitted from a conventional LED backlight unit is fixed, the use of cells (i.e. color filters) provided in a liquid crystal panel is required to adjust color coordinates, and therefore, display and chromaticity should be adjusted simultaneously, which is disadvantageous in terms of luminous efficiency.

On the other hand, LED packages for backlight units suffer from the problem that changes in ambient conditions, such as external temperature and/or non-uniform voltage, cause variations in light output of LED chips, tending to change color coordinates. A type of LED package for a backlight unit is known in which a fluorescent material (for example, YAG:CE) is arranged on a first LED chip to achieve white light emission. This type of LED package is difficult to produce on a large scale with the same color coordinates and has a disadvantage in that its color temperature and color rendering index are difficult to adjust. Another type of LED package for a backlight unit is known in which a combination of a first LED chip, a green phosphor, and a red green phosphor is used to achieve white light emission. However, due to the limited full widths at half maximum (FWHM) of the emission spectra of the red phosphor and the green phosphor, there is a limitation in increasing the color gamut and reproducibility of the LED package. Particularly, BT2020 requires monochromatic RGB primaries and establishes the widest color gamut. A conventional LED package for a backlight unit using a red phosphor and a green phosphor covers less than 90% of the BT2020 color gamut and has a limitation in providing a wide color gamut. There arises a need to reduce the full widths at half maximum (FWHM) of three primary colors in order to achieve the BT2020 wide color gamut. In an attempt to meet this need, a combination of a first LED chip, a second LED chip, and a red phosphor has been proposed to obtain white light. However, this proposal is disadvantageous in that considerable loss of light from the second LED chip is caused in an area where blue light emitted from the first LED chip excites the red phosphor. Currently widely used red phosphors are limited in satisfactorily fulfilling various requirements.

### SUMMARY OF THE INVENTION

It is one object of the present invention to provide LED display devices that use a backlight unit including a group of first LEDs and a group of second LEDs with different color coordinates to primarily adjust color coordinates so that the use of color filters for adjustment of color coordinates can be reduced compared to the prior art.

It is a further object of the present invention to provide LED packages for high-luminance backlight units that use a combination of a first LED chip, a second LED chip, and a red phosphor to obtain white light and minimize loss of light from the second LED chip in an area where blue light emitted from the first LED chip excites the red phosphor, achieving the BTE 2020 wide color gamut and improved color reproducibility while maintaining high brightness.

According to a first aspect of the present invention, there is provided a display device including: a liquid crystal panel including color filters; and a backlight unit including a light guide plate arranged in rear of the liquid crystal panel and a bar-type LED module arranged at one side of the light guide plate to supply backlight to the one side of the light guide plate, wherein the bar-type LED module includes: a substrate elongated along the one side of the light guide plate; a plurality of LED packages arrayed on the substrate and each including a first LED emitting first white light and a second LED emitting second white light and separated from the first LED by a partition wall; a first wiring connecting the first LEDs of the plurality of LED packages in series; a second wiring connecting the second LEDs of the plurality of LED packages in series; and a control unit controlling the ratio of a current applied to the first LEDs and a current applied to the second LEDs to adjust the color coordinates of backlight produced by the first white light and the second white light, and wherein the control unit adjusts the color coordinates of the backlight along a straight line connecting the color coordinates of the first white light and the color coordinates of the second white light.

According to one embodiment, the X and Y values of the color coordinates of the second white light are greater than those of the color coordinates of the first white light.

According to one embodiment, the color coordinates of the first white light are preferably (0.207<X<0.257, 0.160<Y<0.210) and the color coordinates of the second white light are preferably (0.316<X<0.366, 0.313<Y<0363).

According to one embodiment, each of the LED packages includes a first cavity and a second cavity separated by the partition wall, the first LED is constructed by a combination of a first LED chip and a first phosphor located in the first cavity, and the second LED is constructed by a combination of a second LED chip and a second phosphor located in the second cavity.

According to one embodiment, the first LED chips and the second LED chips are blue LED chips, the first phosphor is a yellow phosphor, and the second phosphor is a mixture of a yellow phosphor and an orange phosphor.

According to a second aspect of the present invention, there is provided a display device including: a liquid crystal panel including color filters; and a backlight unit including a light guide plate arranged in rear of the liquid crystal panel and a bar-type LED module arranged at one side of the light guide plate to supply backlight to the one side of the light guide plate, wherein the bar-type LED module includes: a substrate elongated along the one side of the light guide plate; a plurality of first packages arrayed on the substrate and emitting first white light; a plurality of second packages arrayed alternately with the first packages on the substrate and emitting second white light; a first wiring connecting the first packages in series; a second wiring connecting the second packages in series; and a control unit controlling the ratio of a current applied to the first packages and a current applied to the second packages to adjust the color coordinates of backlight produced by the first white light and the second white light, and wherein the control unit adjusts the color coordinates of the backlight along a straight line connecting the color coordinates of the first white light and the color coordinates of the second white light.

According to one embodiment, the color filters secondarily adjust the color coordinates of the light that have been primarily adjusted by the backlight unit.

According to one embodiment, the X and Y values of the color coordinates of the second white light are greater than those of the color coordinates of the first white light.

According to one embodiment, the color coordinates of the first white light are preferably (0.207<X<0.257, 0.160<Y<0.210) and the color coordinates of the second white light are preferably (0.316<X<0.366, 0.313<Y<0363).

According to one embodiment, when the control unit adjusts the color coordinates of the backlight, the first packages and the second packages are always turned on.

According to a third aspect of the present invention, there is provided a display device including: a liquid crystal panel including color filters; and a backlight unit including a light guide plate arranged in rear of the liquid crystal panel and a bar-type LED module arranged at one side of the light guide plate to supply backlight to the one side of the light guide plate, wherein the display device includes: a wavelength converting sheet arranged between the bar-type LED module and the liquid crystal panel; a substrate elongated along the one side of the light guide plate; a plurality of LED packages arrayed on the substrate and each including a first LED cooperating with the wavelength converting sheet to emit first white light and a second LED cooperating with the wavelength converting sheet to emit second white light and separated from the first LED by a partition wall; a first wiring connecting the first LEDs of the plurality of LED packages in series; a second wiring connecting the second LEDs of the plurality of LED packages in series; and a control unit controlling the ratio of a current applied to the first LEDs and a current applied to the second LEDs to adjust the color coordinates of backlight produced by the first white light and the second white light, and wherein the color coordinates of the backlight are adjusted along a straight line connecting the color coordinates of the first white light and the color coordinates of the second white light.

According to one embodiment, the color filters secondarily adjust the color coordinates of the light that have been primarily adjusted by the backlight unit.

According to one embodiment, the X and Y values of the color coordinates of the second white light are greater than those of the color coordinates of the first white light.

According to one embodiment, the first LEDs are blue LEDs and the second LEDs are white LEDs.

According to one embodiment, the wavelength converting sheet includes quantum dots.

According to a fourth aspect of the present invention, there is provided a display device including: a liquid crystal panel including color filters; and a backlight unit including a light guide plate arranged in rear of the liquid crystal panel and a bar-type LED module arranged at one side of the light guide plate to supply backlight to the one side of the light guide plate, wherein the display device includes: a wavelength converting sheet arranged between the bar-type LED module and the liquid crystal panel; a substrate elongated along the one side of the light guide plate; a plurality of first packages arrayed on the substrate and cooperating with the wavelength converting sheet to emit first white light; a plurality of second packages arrayed alternately with the first packages on the substrate and cooperating with the wavelength converting sheet to emit second white light; a first wiring connecting the first packages in series; a second wiring connecting the second packages in series; and a control unit controlling the ratio of a current applied to the first packages and a current applied to the second packages to adjust the color coordinates of backlight produced by the first white light and the second white light, and wherein the color coordinates of the backlight are adjusted along a straight line connecting the color coordinates of the first white light and the color coordinates of the second white light.

According to one embodiment, the color filters secondarily adjust the color coordinates of the light that have been primarily adjusted by the backlight unit.

According to one embodiment, the first packages are blue LEDs and the second packages are white LEDs.

According to one embodiment, the wavelength converting sheet includes quantum dots.

According to one embodiment, the color coordinates of the first white light are (0.207<X<0.257, 0.160<Y<0.210) and the color coordinates of the second white light are (0.316<X<0.366, 0.313<Y<0363).

According to one aspect of the present invention, there is provided an LED package that can be applied, in part or in whole, to the above-described backlight units. The LED package includes: a reflector having a first cavity and a second cavity separated by a barrier; a first LED chip arranged in the first cavity and emitting blue light; a second LED chip arranged in the second cavity and emitting green light; a fluorescent resin part formed in the first cavity and embedded with a red phosphor converting blue light emitted from the first LED chip into red light; and a transparent resin part formed in the second cavity and covering the second LED chip, wherein the red light has a peak wavelength of 640 nm to 650 nm and a full width at half maximum (FWHM) of less than 60 nm. The response time of the red phosphor may be less than 1 μs. The red phosphor may be Sr[LiAl3N4]Eu2+. The green light may have a peak wavelength of 520 nm to 530 nm. The barrier prevents the green light emitted from the second cavity from being mixed with the red light emitted from the first cavity. The transparent resin part is made of a clear silicone resin. The top end of the barrier may be at the same level as or higher than that of the fluorescent resin part. The reflector may include a first inclined wall formed in the first cavity and facing a first side of the barrier and a second inclined wall formed in the second cavity and facing a second side of the barrier. The first side and the second side may be upright. Alternatively, the first side and the second side may be inclined. A current control unit may be further provided to apply different currents to the first LED chip and the second LED chip. The LED package may further include a base mounted with the first LED chip and the second LED chip. First, second, third, and fourth upper electrode pads connected to a first conductive electrode and a second conductive electrode of the first LED chip and a first conductive electrode and a second conductive electrode of the second LED chip, respectively, are formed on the upper surface of the base and first, second, third, and fourth lower electrode pads corresponding to the first, second, third, and fourth upper electrode pads, respectively, are formed on the lower surface of the base.

According to a further aspect of the present invention, there is provided an LED package that can be applied, in part or in whole, to the above-described backlight units. The LED package includes: a first reflector having a first cavity; a second reflector separated from the first reflector and having a second cavity; a first LED chip arranged in the first cavity and emitting blue light; a second LED chip arranged in the second cavity and emitting green light; a fluorescent resin part formed in the first cavity and embedded with a red phosphor converting blue light emitted from the first LED chip into red light; and a transparent resin part formed in the second cavity and covering the second LED chip, wherein the red light has a peak wavelength of 640 nm to 650 nm and a full width at half maximum (FWHM) of less than 60 nm.

Each of the display devices of the present invention uses not only RGB color filters provided in a liquid crystal panel for adjustment of color coordinates but also a backlight unit including a group of first LEDs and a group of second LEDs with different color coordinates for primary adjustment of coloring coordinates so that the use of color filters for adjustment of color coordinates can be reduced compared to the prior art. Therefore, the use of the backlight unit can significantly prevent luminous efficiency from deterioration resulting from the blocking of light by the color filters. According to one embodiment of the present invention, two color LEDs are integrated in one LED package so that the distance between luminescent windows of the two color LEDs can be minimized, with the result that the occurrence of unwanted color separation is minimized.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 conceptually illustrates a display device according to a first embodiment;

FIG. 2 is a plan view illustrating a backlight unit of the display device according to the first embodiment;

FIG. 3 illustrates a bar-type LED module employed in the backlight unit illustrated in FIG. 2;

FIG. 4 is a circuit diagram of the LED module illustrated in FIGS. 2 and 3;

FIG. 5 is a CIE 1931 chromaticity diagram showing the adjustment of the color coordinates of backlight by the backlight unit illustrated in FIGS. 1 to 4;

FIG. 6 illustrates a bar-type LED module according to a second embodiment;

FIG. 7 illustrates a display device according to a third embodiment;

FIG. 8 is a CIE 1931 chromaticity diagram showing the adjustment of the color coordinates of backlight by the backlight unit illustrated in FIG. 7;

FIG. 9A is a perspective view illustrating an LED package for a backlight unit according to one embodiment of the present invention;

FIG. 9B is a cross-sectional view illustrating an LED package for a backlight unit according to one embodiment of the present invention;

FIG. 10 is a perspective view illustrating an LED package for a backlight unit according to a further embodiment of the present invention;

FIG. 11 is a cross-sectional view of an LED package for a backlight unit according to a further embodiment of the present invention;

FIG. 12 illustrates exemplary lower electrode pads for power input/output that are applicable to an LED package for a backlight unit;

FIG. 13 is a circuit diagram applicable to an LED package for a backlight unit;

FIG. 14 illustrates an LED package for a backlight unit according to another embodiment of the present invention;

FIGS. 15 and 16 illustrate LED packages for backlight units according to exemplary embodiments of the present invention;

FIG. 17 is an emission spectrum of an LED package for a backlight unit; and

FIG. 18 compares the color gamut provided by an LED package for a backlight unit according to the present invention with the BT2020 color gamut and the color gamut provided by a comparative example.

### DETAILED DESCRIPTION OF THE INVENTION

Preferred embodiments of the present invention will now be described with reference to the accompanying drawings. It should be noted that the drawings and embodiments are simplified and illustrated such that those skilled in the art can readily understand the present invention.

[Display Devices]

### First Embodiment

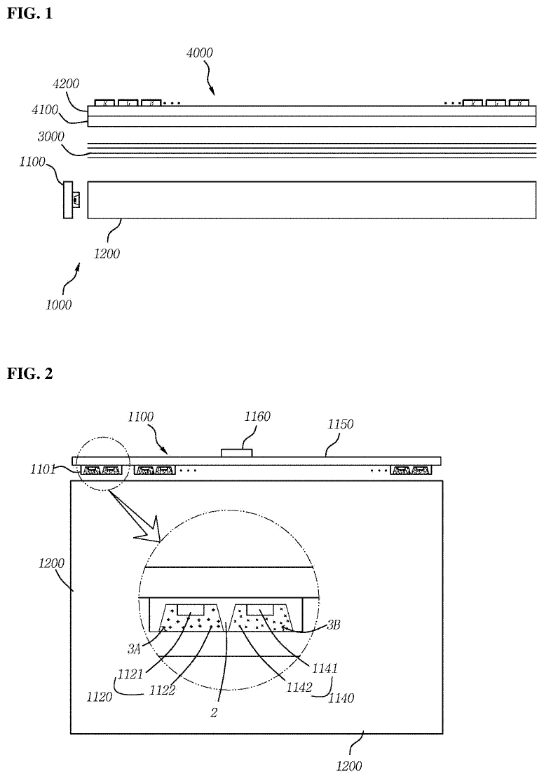

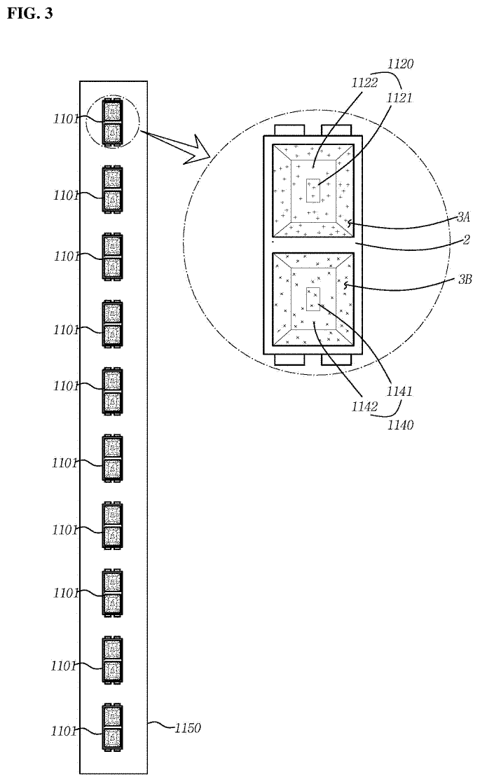

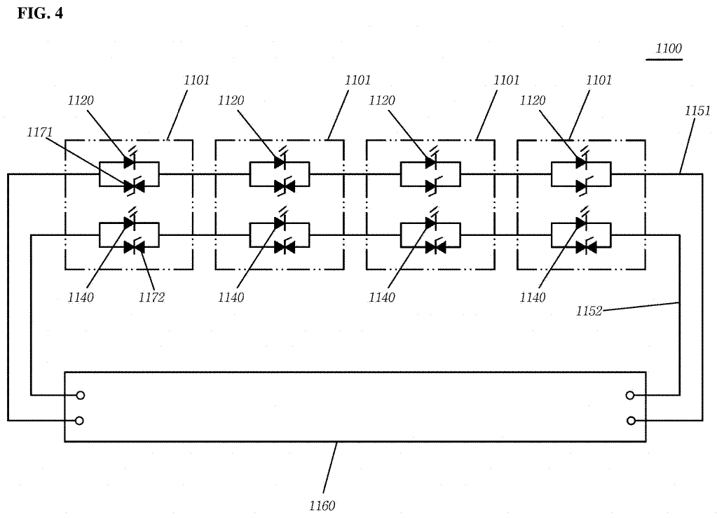

FIG. 1 conceptually illustrates a display device according to a first embodiment, FIG. 2 is a plan view illustrating a backlight unit of the display device according to the first embodiment, FIG. 3 illustrates a bar-type LED module employed in the backlight unit illustrated in FIG. 2, FIG. 4 is a circuit diagram of the LED module illustrated in FIGS. 2 and 3, and FIG. 5 is a CIE 1931 chromaticity diagram showing the adjustment of the color coordinates of backlight by the backlight unit illustrated in FIGS. 1 to 4.

Referring to FIG. 1, the display device includes a liquid crystal panel 4000 and an LED backlight unit 1000 arranged in rear of the liquid crystal panel 4000 to supply backlight to the liquid crystal panel 4000. Transparent glass (not illustrated) may be arranged in front of the liquid crystal panel 4000. A plurality of optical sheets 3000 including a diffusion sheet may be arranged between the liquid crystal panel 4000 and the LED backlight unit 1000. An OCR film may also be provided between the transparent glass and the liquid crystal panel 4000 to enhance the brightness of display light.

The liquid crystal panel 4000 is constructed such that pixels arrayed in a matrix output images. The liquid crystal panel 4000 includes a color filter substrate 4200 and an array substrate 4100 facing and laminated with each other and a liquid crystal layer (not illustrated) formed in a cell gap between the color filter substrate 4200 and the array substrate 4100. A common electrode and pixel electrodes are disposed in the liquid crystal panel 4000 including the color filter substrate 4200 and the array substrate 4100 laminated with each other and an electric field is applied to the liquid crystal layer through the electrodes. When voltages of data signals applied to the pixel electrodes are controlled in a state in which a voltage is applied to the common electrode, the liquid crystal molecules present in the liquid crystal layer rotate by dielectric anisotropy in response to the electric field between the common electrode and the pixel electrodes so that the pixels selectively transmit or block incident light to display text and images. Switching elements such as thin film transistors (TFTs) may be individually provided in the pixels to control the voltages of data signals applied to the pixel electrodes in the individual pixels.

Gate lines and data lines are arrayed longitudinally and transversely on the array substrate 4100 to define pixel regions and thin film transistors as the switching elements are disposed at the intersections between the gate lines and the data lines.

The color filter substrate 4200 includes color filters corresponding to the pixels. Each of the color filters includes an R filter, a G filter, and a B filter as sub-color filters. A black matrix may be formed to isolate the sub-color filters and block light passing through the liquid crystal layer.

The backlight unit 1000 includes a light guide plate 1200 arranged in rear of the liquid crystal panel 4000 and a bar-type LED module 1100 arranged at one side of the light guide plate 1200 to supply backlight to the one side of the light guide plate 1200. The light guide plate 1200 guides light entering through the one side such that the light is emitted through the front side and supplied to the liquid crystal panel 4000. A reflective film, a reflective pattern or a reflective part (not illustrated) is disposed on the rear surface of the light guide plate 1200 to assist in light reflection. For example, the plurality of optical sheets 3000 including a diffusion sheet may be arranged between the light guide plate 1200 and the liquid crystal panel 4000.

Referring to FIGS. 2, 3, and 4, the LED backlight unit 1000 includes: a plurality of LED packages 1101 elongated and arrayed along the one side of the light guide plate 1200 and each including a first LED 1120 emitting first white light and a second LED 1140 emitting light having a color temperature different from that of the first white light and adjacent to the first LED 1120; a bar-type printed circuit board 1150 mounted with the plurality of LED packages 1101 and including a first wiring 1151 electrically connecting the first LEDs 1120 in series and a second wiring 1152 electrically connecting the second LEDs 1140 in series; and a control unit 1160 controlling a current applied to the first LEDs 1120 connected in series through the first wiring 1151 and a current applied to the second LEDs 1140 connected in series through the second wiring 1152.

The first LEDs 1120 and the second LEDs 1140 are arrayed alternately in the array of the LED packages 1101. Each of the LED packages 1101 includes a first cavity 3A and a second cavity 3B separated by a partition wall 2, each of the first LEDs 1120 is constructed by a combination of a first LED chip 1121 and a first phosphor 1122 arranged in the first cavity 3A, and each of the second LEDs 1140 is constructed by a combination of a second LED chip 1141 and a second phosphor 1142 arranged in the second cavity 3B. In each of the packages, the first LED 1120 and the second LED 1140 are adjacent to each other through the partition wall 2. With this arrangement, the first white light emitted from the first LEDs 1120 is very advantageously mixed with the second white light emitted from the second LEDs 1140.

Each of the LED packages 1101 includes a first Zener diode connected in parallel with the corresponding first LED 1120 and a second Zener diode 1172 connected in parallel with the corresponding second LED 1140. The first Zener diodes 1171 and the second Zener diodes 1172 serve to protect the first LEDs 1120, the second LEDs 1140, and other essential elements from a surge overvoltage such as static electricity. The first Zener diodes 1171 and the second Zener diodes 1172 are preferably bi-directional.

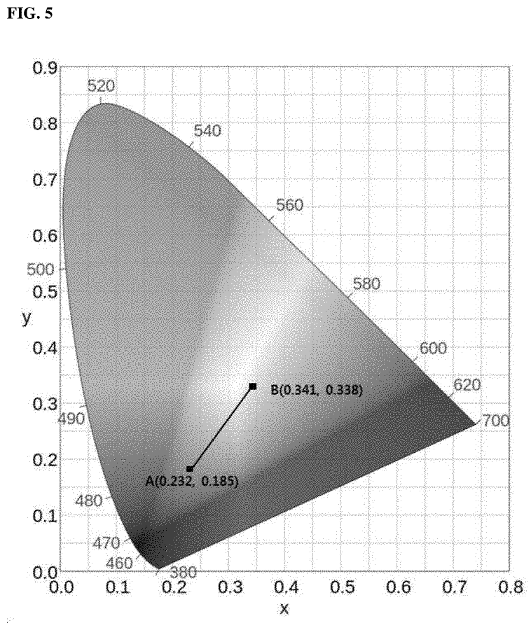

Referring to FIG. 5 together with FIGS. 1 to 4, the first LEDs 1120 are constructed to emit first white light having color coordinates (0.232, 0.185) on the CIE 1931 chromaticity diagram and the second LEDs 1140 are constructed to emit second white light having color coordinates (0.341, 0.338) whose X and Y values are greater than those of the color coordinates of the first white light emitted from the first LEDs 1120. Hereinafter, the color coordinates of light emitted from the first LEDs 1120 are referred to as “color coordinates A” and the color coordinates of light emitted from the second LEDs 1140 are referred to as “color coordinates B”.

In this embodiment, the color coordinates A and the color coordinates B are fixed to (0.232, 0.185) and (0.341, 0.338), respectively. However, the color coordinates A and the color coordinates B are not limited as long as they satisfy (0.207<X<0.257, 0.160<Y<0.210) and (0.316<X<0.366, 0.313<Y<0363), respectively. Color coordinates outside these ranges cause poor color reproducibility, are impossible to implement because they are beyond the ability of the backlight unit to adjust color coordinates, or increase the amount of light blocked by the color filters because of the limited ability of the backlight unit to adjust color coordinates, resulting in low luminous efficiency.

The control unit 1160 controls a current applied to the first LEDs (or their LED chips) connected in series through the first wiring 1151 and a current applied to the second LEDs (or their LED chips) connected in series through the second wiring 1152 to adjust the intensities (or fluxes) of light emitted from the first LEDs 1120 and the second LEDs 1140. More specifically, the control unit 1160 controls the ratio of a current applied to the first LEDs 1120 and a current applied to the second LEDs 1140 to vary the ratio of the intensity of light emitted from the first LEDs 1120 to the intensity of light emitted from the second LEDs 1140, so that the color coordinates of backlight can be adjusted along a straight line connecting the color coordinates A and the color coordinates B.

The control unit 1160 enables the adjustment of the total intensity and the color coordinates of backlight. In addition, the control unit 1160 controls a current applied to the first LEDs 1120 and a current applied to the second LEDs 1140 to vary the ratio of the total intensity of light emitted from the first LEDs 1120 to the total intensity of light emitted from the second LEDs 1140 while maintaining the sum of the intensity of light emitted from the first LEDs 1120 and the intensity of light emitted from the second LEDs 1140.

A sports viewing mode requires white backlight with a large amount of blue component. In this mode, the control unit 1160 is operated in response to signal input such that a relatively large amount of current is applied to the first LEDs 1120 and a relatively small amount of current is applied to the second LEDs 1140 to produce backlight closer to the color coordinates A than to the color coordinates B. The backlight is supplied to the liquid crystal panel 4000 (see FIG. 1). At this time, since there is a limitation in the range of color coordinates that can be adjusted by the LED backlight unit 1000 (see FIG. 1), a greater number of the color filters of the liquid crystal panel 4000 (see FIG. 1) participate in the adjustment of color coordinates such that the amount of blue component is relatively large compared to the amounts of red component and green component. At this time, when the current applied to one of the two groups of first LEDs 1120 and second LEDs 1140 reaches a maximum, the current applied to the other group falls to a minimum. Although a minimum current is supplied to the corresponding LEDs, the corresponding LEDs are always kept on rather than off.

Another control unit for the color filters may be responsible for the control of the liquid crystal panel 4000 (see FIG. 1). Alternatively, integration of the function of the control unit for the color filters into the control unit 1160 of the backlight unit 1000 (see FIG. 1) can also be considered.

On the other hand, the second LEDs 1140 may include a red phosphor whose wavelength conversion efficiency is relatively low such that the ratio of the current applied to the second LEDs 1140 to the intensity of light emitted from the second LEDs 1140 is greater than the ratio of the current applied to the first LEDs 1120 to the intensity of light from the first LEDs 1120. The difference between the ratio of the current applied to the second LEDs to the intensity of light from the second LEDs and the ratio of the current applied to the first LEDs to the intensity of light from the first LEDs increases as the color temperature of light emitted from the LED module is shifted from the color coordinates A toward the color coordinates B.

In this embodiment, the first LEDs 1120 are preferably combinations of blue LED chips and a YAG yellow phosphor and the second LEDs 1140 are preferably combinations of blue LED chips, a YAG yellow phosphor, and an α-SiAlON orange phosphor.

### Second Embodiment

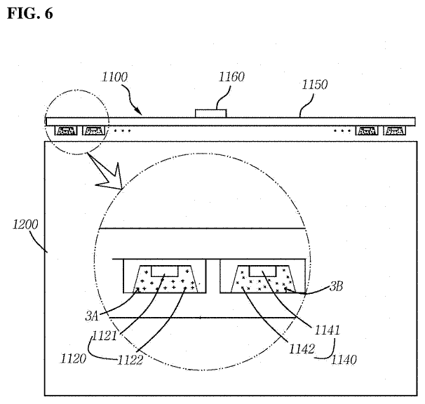

FIG. 6 illustrates a bar-type LED module according to a second embodiment.

The bar-type LED module includes a plurality of package-type LEDs 1120 and 1140 elongated and arrayed along one side of a light guide plate 1200. The package-type LEDs 1120 and 1140 includes a plurality of first LEDs 1120 emitting first white light having color coordinates A (0.207<X<0.257, 0.160<Y<0.210) and a plurality of second LEDs 1140 emitting second white light having color coordinates A (0.316<X<0.366, 0.313<Y<0363). Each of the first LEDs 1120 is constructed by a combination of a first LED chip 1121, for example, a blue LED chip, and a first phosphor 1122, i.e. a yellow phosphor, and each of the second LEDs 1140 is constructed by a combination of a second LED chip 1141, for example, a blue LED chip, and a second phosphor 1142, i.e. a yellow phosphor. The first LEDs 1120 and the second LEDs 1140 exist in independent packages and are arrayed alternately along the lengthwise direction. This embodiment is the same as the previous embodiment except that the first LEDs 1120 and the second LEDs 1140 exist in independent packages.

### Third Embodiment

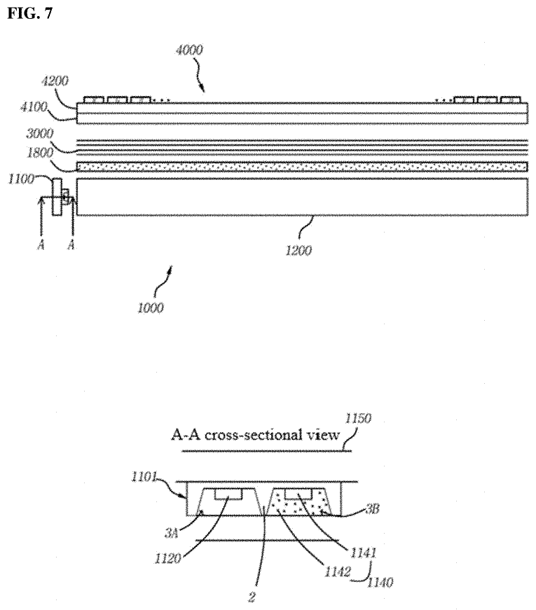

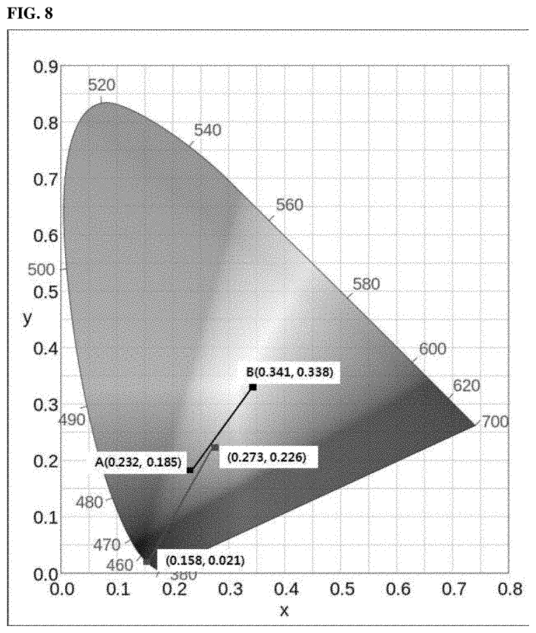

FIG. 7 illustrates a display device according to a third embodiment and FIG. 8 is a CIE 1931 chromaticity diagram showing the adjustment of the color coordinates of backlight from the backlight unit illustrated in FIG. 7.

Referring to FIGS. 7 and 8, the display device includes a liquid crystal panel 4000 and a backlight unit 1000 arranged in rear of the liquid crystal panel 4000 to supply backlight to the liquid crystal panel 4000 and including a light guide plate 1200 and a bar-type LED module 1100 arranged at one side of the light guide plate 1200.

Transparent glass may be arranged in front of the liquid crystal panel 4000. A plurality of optical sheets 3000 including a diffusion sheet may be arranged between the liquid crystal panel 4000 and the backlight unit 1000. An OCR film may also be provided between the transparent glass and the liquid crystal panel 4000 to enhance the brightness of display light.

The light guide plate 1200 is arranged in rear of the liquid crystal panel 4000 and the bar-type LED module 1100 is arranged at one side of the light guide plate 1200 to supply backlight to the one side of the light guide plate 1200. A wavelength converting sheet 1800 is arranged between the liquid crystal panel 4000 and the light guide plate 1200. The wavelength converting sheet 1800 is preferably a quantum dot sheet including quantum dots. Quantum dots cause less light loss than phosphors during wavelength conversion.

The light guide plate 1200 guides light entering through the one side such that the light is emitted through the front surface and supplied to the liquid crystal panel 4000. A reflective film, a reflective pattern or a reflective part is disposed on the rear surface of the light guide plate 1200 to assist in light reflection. For example, the plurality of optical sheets including a diffusion sheet may be arranged between the light guide plate 1200 and the liquid crystal panel 4000.

The bar-type LED module 1100 includes: a plurality of LED packages 1101 elongated and arrayed along the one side of the light guide plate 1200 and each including a first LED 1120 emitting blue light and a second LED 1140 adjacent to the first LED 1120; a bar-type printed circuit board 1150 mounted with the plurality of LED packages 1101 and including a first wiring 1151 electrically connecting the first LEDs 1120 in series and a second wiring 1152 electrically connecting the second LEDs 1140 in series; and a control unit 1160 (see FIG. 4) controlling a current applied to the first LEDs 1120 connected in series through the first wiring 1151 and a current applied to the second LEDs 1140 connected in series through the second wiring 1152.

The first LEDs 1120 and the second LEDs 1140 are arrayed alternately in the array of the LED packages 1101. Each of the LED packages 1101 includes a first cavity 3A and a second cavity 3B separated by a partition wall 2, each of the first LEDs 1120 is constructed by a blue LED chip as a first LED chip 1121 arranged in the first cavity 3A, and each of the second LEDs 1140 is constructed by a combination of a blue LED chip as a second LED chip 1141 arranged in the second cavity 3B and a phosphor 1142. In each of the packages, the first LED 1120 and the second LED 1140 are adjacent to each other through the partition wall 2. With this arrangement, the blue light emitted from the first LEDs 1120 is very advantageously mixed with the second white light emitted from the second LEDs 1140.

In this embodiment, the first LEDs 1120 are blue LEDs independently emitting blue light having color coordinates (0.158, 0.021) on the CIE 1931 chromaticity diagram and cooperate with the wavelength converting sheet 1800 to produce first white light having color coordinates (0.232, 0.185) (“color coordinates A”). The second LEDs 1140 are white LEDs independently emitting white light having color coordinates (0.273, 0.226) on the CIE 1931 chromaticity diagram and cooperate with the wavelength converting sheet 1800 to produce second white light having color coordinates (0.341, 0.338) (“color coordinates B”) whose X and Y values are greater than those of the color coordinates of the first white light.

In this embodiment, the color coordinates A and the color coordinates B are fixed to (0.232, 0.185) and (0.341, 0.338), respectively. However, the color coordinates A and the color coordinates B are not limited as long as they satisfy (0.207<X<0.257, 0.160<Y<0.210) and (0.316<X<0.366, 0.313<Y<0363), respectively. Color coordinates outside these ranges cause poor color reproducibility, are impossible to implement because they are beyond the ability of the backlight unit to adjust color coordinates, or increase the amount of light blocked by the color filters because of the limited ability of the backlight unit to adjust color coordinates, resulting in low luminous efficiency. The control unit 1160 controls a current applied to the first LEDs 1120 connected in series through the first wiring 1151 and a current applied to the second LEDs 1140 connected in series through the second wiring 1152 to adjust the intensities (or the fluxes) of light emitted from the first LEDs 1120 and the second LEDs 1140. More specifically, the control unit 1160 controls the ratio of a current applied to the first LEDs 1120 and a current applied to the second LEDs 1140 to vary the ratio of the intensity of light emitted from the first LEDs 1120 to the intensity of light emitted from the second LEDs 1140, so that the color coordinates of backlight can be adjusted along a straight line connecting the color coordinates A and the color coordinates B. The control unit enables the adjustment of the total intensity and the color coordinates of backlight. In addition, the control unit controls a current applied to the first LEDs 1120 and a current applied to the second LEDs 1140 to vary the ratio of the total intensity of light emitted from the first LEDs 1120 to the total intensity of light emitted from the second LEDs 1140 while maintaining the sum of the intensity of light from the first LEDs 1120 and the intensity of light emitted from the second LEDs 1140.

Direct application of quantum dots to the LED packages can be considered rather than to the wavelength converting sheet. However, quantum dots applied to an encapsulation or molding material for the LED packages undesirably tend to carbonize due to their susceptibility to heat. Thus, it is preferred to apply quantum dots to the wavelength converting sheet spaced a distance from the LED packages. Particularly, a reduced concentration of quantum dots can be applied to the large-area wavelength converting sheet, which is economically advantageous.

[LED Packages for Backlight Units]

The LED packages used in the backlight units for the display devices described above can be replaced by LED packages for backlight units which are described below. Alternatively, it is noted that the above-described LED packages for backlight units can use some of the elements and features of LED packages for backlight units which are described below.

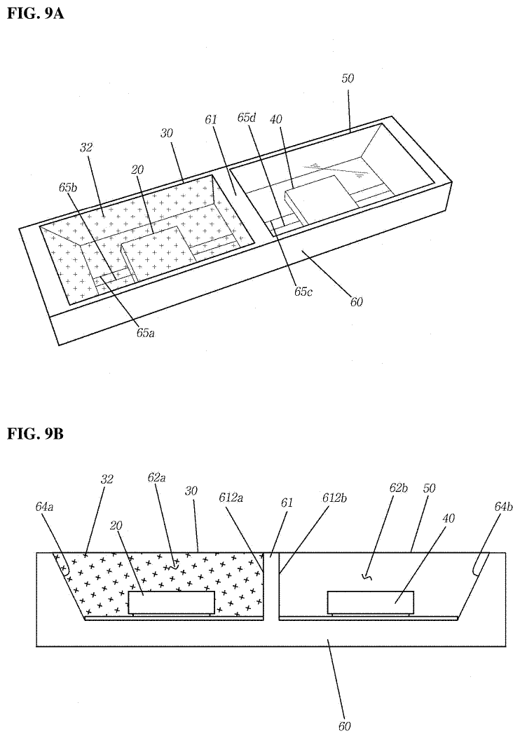

FIG. 9A is a perspective view illustrating an LED package for a backlight unit according to one embodiment of the present invention and FIG. 9B is a cross-sectional view illustrating an LED package for a backlight unit according to one embodiment of the present invention.

Referring to FIGS. 9A and 9B, the LED package is used as a backlight source for a display device such as an LCD device and includes a first LED chip 20 emitting blue light, a second LED chip 40 arranged in the vicinity of the first LED chip 20 and emitting green light, a red phosphor 32 excited by a portion of the blue light to emit red light, and isolation means isolating the blue light and the green light in an area where the blue light excites the red phosphor.

The LED package includes a reflector 60 accommodating the first LED chip 20 and the second LED chip 40. The isolation means includes a barrier 61 as a portion of the reflector 60.

The reflector 60 may be made by molding a mixture of a resin material and one or more particulate reflective materials such as TiO₂ or SiO₂. An EMC, PCT or PPA-based molding resin can be advantageously used as the resin material. The reflector 60 includes an upwardly open space accommodating the first LED chip 20, the red phosphor 32, and the second LED chip 40. The space includes a first cavity 62a and a second cavity 62b separated from each other by the barrier 61. The first LED chip 20 and the red phosphor 32 are accommodated in the first cavity 62a and the second LED chip 40 is accommodated in the second cavity 62b. In this embodiment, the red phosphor 32 is dispersed in a transparent resin, preferably a silicone resin, in the first cavity 62a. The red phosphor 32 is dispersed in the resin in the first cavity 62a to form a fluorescent resin part 30.

The reflector 60 includes a first upper electrode pad 65a and a second upper electrode pad 65b disposed on the bottom of the first cavity 62a and a third upper electrode pad 65c and a fourth upper electrode pad 65d disposed on the bottom of the second cavity 62b. The first LED chip 20 is mounted on the bottom of the first cavity 62a and the second LED chip 40 is mounted on the bottom of the second cavity 62b. Each of the first LED chip 20 and the second LED chip 40 includes a first conductive electrode and a second conductive electrode disposed on the underside thereof. The first conductive electrode is connected to a first conductive semiconductor layer and the second conductive electrode is connected to a second conductive semiconductor layer. When the first LED chip 20 is mounted on the bottom of the first cavity 62a, the first conductive electrode of the first LED chip 20 is bonded to the first upper electrode pad 65a and the second conductive electrode of the first LED chip 20 is bonded to the second upper electrode pad 65b. When the second LED 40 is mounted on the bottom of the second cavity 62b, the first conductive electrode of the second LED chip 40 is bonded to the third upper electrode pad 65c and the second conductive electrode of the second LED chip 40 is bonded to the fourth upper electrode pad 65d. The first upper electrode pad, the second upper electrode pad, the third upper electrode pad, and the fourth upper electrode pad constitute portions of the reflector 60 or are disposed on the upper surface of a base bonded to the reflector 60. A first lower electrode pad, a second lower electrode pad, a third lower electrode pad, and a fourth lower electrode pad corresponding to the first upper electrode pad 65a, the second upper electrode pad 65b, the third upper electrode pad 65c, and the fourth upper electrode pad 65d, respectively, may be disposed on the lower surface of the base. The upper electrode pads are connected to the corresponding lower electrode pads through vias or metal leads. Due to this construction, the first LED chip 20 and the second LED chip 40 can be arrayed in parallel. In addition, different currents can be applied to the first LED chip 20 and the second LED chip 40 by a current control unit even when the LED chips are operated by a single power supply. The current control unit will be described below.

The top end of the barrier 61 is at the same level as or higher than that of the fluorescent resin part 30. With these dimensions, light emitted from the second LED chip 40 can be isolated from the red phosphor 32 in an area where the first LED chip 20 excites the red phosphor 32 to convert the red wavelength. The light having passed through the red wavelength conversion area is mixed with the blue light and the green light to produce white light.

The barrier 61 includes a first upright side 612a and a second upright side 612b parallel to each other. The reflector 60 includes a first inclined wall 64a formed in the first cavity and facing the first side 612a of the barrier 61 and a second inclined wall 64b formed in the second cavity and facing the second side 612b of the barrier 61. The reflector 60 and the barrier 61 as a portion of the reflector 60 may be reflective walls, more specifically white walls.

The fluorescent resin part 30 including the red phosphor 32 in the first cavity 62a completely covers the upper surface and the side surfaces of the first LED chip 20. A transparent resin part 50 covering the second LED chip 40 is formed in the second cavity 62b. The fluorescent resin part 30 may be formed by filling the first cavity 62a with a dispersion of the red phosphor in a flowable silicone resin. The transparent resin part 50 is formed by filling the first cavity 62a with a flowable clear silicone resin.

The reflector 60 may be made by molding such that its portion constitutes the barrier 61. Alternatively, it is noted that the reflector including a large space accommodating the LED chips and the phosphor is made and the barrier 61 is formed in the space to divide the space into the first cavity and the second cavity. In the former case, the barrier 61 as a portion of the reflector 60 is made of the same material as the reflector 60. In the latter case, the reflector 60 may be made of a different material from the reflector 60.

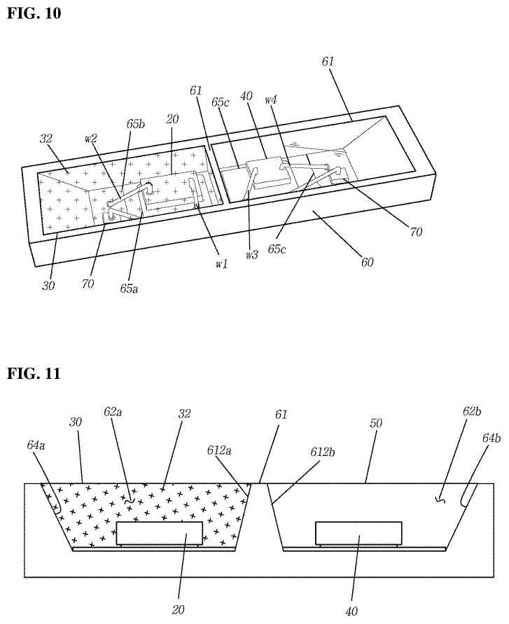

FIG. 10 is a perspective view illustrating an LED package for a backlight unit according to a further embodiment of the present invention.

Referring to FIG. 10, the LED package includes a first LED chip 20 and a second LED chip 40. Each of the first LED chip 20 and the second LED chip 40 is a lateral-type LED chip having a first conductive electrode and a second conductive electrode disposed on the top thereof. As in the foregoing embodiments, a first upper electrode pad 65a, a second upper electrode pad 65b, a third upper electrode pad 65c, and a fourth upper electrode pad 65d constitute portions of the reflector 60 or are disposed on the upper surface of a base bonded to the reflector 60. The first conductive electrode of the first LED chip 20, the second conductive electrode of the first LED chip 20, the first conductive electrode of the second LED chip 40, and the second conductive electrode of the second LED chip 40 are connected to the first upper electrode pad 65a, the second upper electrode pad 65b, the third upper electrode pad 65c, and the fourth upper electrode pad 65d through bonding wires w1, w2, w3, and w4, respectively. Zener diodes 70 are further mounted on the bottom of the first cavity and the bottom of the second cavity separated from the first cavity by a barrier 61 to protect the first LED chip 20 and the second LED chip 40, respectively, when a surge voltage such as static electricity is applied to the LED package. Other elements of the LED package are the same as those described in the foregoing embodiments and thus a further description thereof is omitted to avoid duplication.

FIG. 11 is a cross-sectional view of an LED package for a backlight unit according to a further embodiment of the present invention.

Referring to FIG. 11, a barrier 61 includes a first side 612a facing a first inclined wall 64a formed in a first cavity 62a and a second side 612b facing a second inclined wall 64b formed in a second cavity 62b, as in the foregoing embodiments. However, the first side 612a and the second side 612b of the barrier 61 are inclined, a first LED chip 20 and a red phosphor 32 are located between the first inclined side 612a and the first inclined wall 64a, and a second LED chip 40 is located between the second inclined side 612a and the second inclined wall 64b, unlike in the foregoing embodiments. The distance between the first side 612a and the first inclined wall 64a increases gradually along the direction of propagation of light. The distance between the second side 612b and the second inclined wall 64b also increases gradually along the direction of propagation of light.

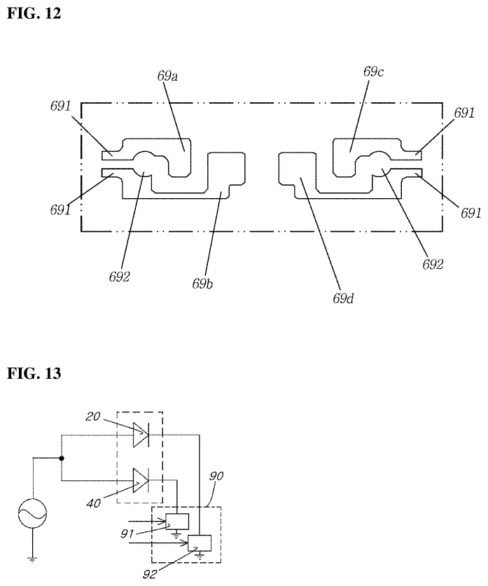

FIG. 12 illustrates exemplary lower electrode pads for power input/output that are applicable to an LED package for a backlight unit according to the present invention. Here, a base is preferably a portion of a reflector made by resin molding. The electrode pads 69a, 69b, 69c, and 69d serve for inputting/outputting power to/from a first LED chip 20 (see FIGS. 9A, 9B, 10, and 11) and a second LED chip 40 (see FIGS. 9A, 9B, 10, and 11). The four lower electrode pads 69a, 69b, 69c, and 69d are separated from and corresponding to a first conductive electrode and a second conductive electrode of the first LED chip 20 (see FIGS. 9A, 9B, 10, and 11) and a first conductive electrode and a second conductive electrode of the second LED chip 40 (see FIGS. 9A, 9B, 10, and 11), respectively. With this arrangement, a current control unit can be provided that controls currents applied to the first LED chip and the second LED chip to different levels. The first lower electrode pad 69a and the second lower electrode pad 69b include tail portions 691 and 691 that are connected to each other but are separated from each other during trimming. Likewise, the third lower electrode pad 69c and the fourth lower electrode pad 69d include tail portions 691 and 691 that are connected to each other but are separated from each other during trimming. The two corresponding tail portions 691 and 691 are spaced a small gap from each other and a wide area 692 having a larger width than the gap is formed adjacent to the gap between the tail portions 691 and 691. In each of the wide areas 692, a hole is formed through which a resin is introduced to form a resin wall or white wall for the reflector that supports the lower electrode pads. Each of the wide areas 692 is formed adjacent to the gap where the two corresponding tail portions 691 and 691 are closest to each other. With this arrangement, the resin can be easily introduced into the small gap.

A circuit diagram applicable to the LED package is shown in FIG. 13.

As shown in FIG. 13, the first LED chip 20 and the second LED chip 40 are arranged in parallel. Four electrode pads are disposed on the upper surface of the base under which the four corresponding lower electrode pads are disposed. Thus, a current control unit 90 can be provided which includes a first current control switch 91 controlling a current applied to the first LED chip 20 and a second current control switch 92 controlling a current applied to the second LED chip 40. For example, the color gamut of a final display device can be extended as desired by controlling the current applied to the second LED chip 40 while maintaining the current applied to the first LED chip 20 at 10 mA.

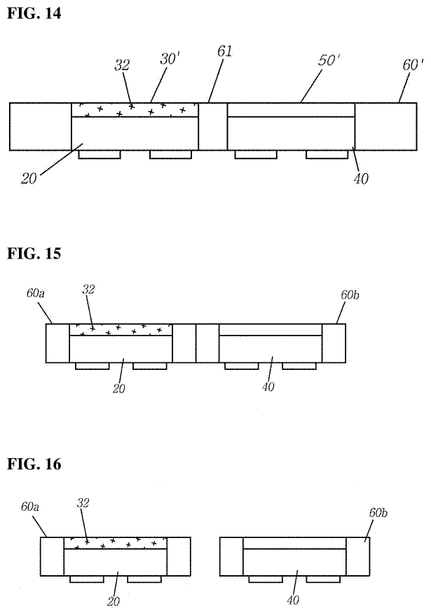

FIG. 14 illustrates an LED package for a backlight unit according to another embodiment of the present invention.

Referring to FIG. 14, the LED package includes a reflector having a white wall 60′ covering the side surfaces of a first LED chip 20 and the side surfaces of a second LED chip 40. Isolation means includes a barrier 61 as a portion of the white wall 60′. A red phosphor layer 30′ including a red phosphor 32 covers the upper surface of the first LED chip 20 and the upper surface of the red phosphor layer 30′ is at the same level as or lower than the top end of the barrier 61. The red phosphor layer 30′ may cover the side surfaces as well as the upper surface of the first LED chip 20. A transparent resin layer 50′ may be formed on the upper surface of the second LED chip 40. Conductive electrodes of the first LED chip 20 and conductive electrodes of the second LED chip 40 protrude downward from the lower end of the white wall 60′.

Each of the LED packages for backlight units according to the foregoing embodiments has a structure in which a first LED chip, a red phosphor, and a second LED chip are accommodated in a single space formed in a single reflector, the space is divided into a first cavity and a second cavity by a barrier, and blue light emitted from the first LED chip accommodated in the first cavity and light emitted from the red phosphor accommodated in the first cavity are isolated from light emitted from the second LED chip accommodated in the second cavity.

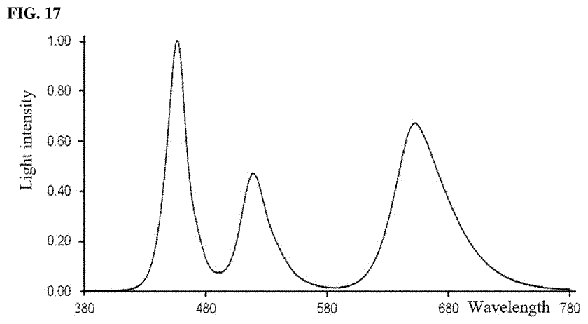

FIGS. 15 and 16 illustrate LED packages for backlight units according to exemplary embodiments of the present invention.

As illustrated in FIGS. 15 and 16, each of the LED packages includes a first reflector 60a having a first cavity in which a first LED chip 20 and a red phosphor 32 are accommodated and a second reflector 60b having a second cavity in which a second LED chip 40 is accommodated without a phosphor. Isolation means includes an outer wall of the first reflector 60a and an outer wall of the second reflector 60b. As illustrated in FIG. 15, the outer wall of the first reflector 60a is in close contact with the outer wall of the second reflector 60b. Alternatively, the outer wall of the first reflector 60a is spaced apart from the outer wall of the second reflector 60b, as illustrated in FIG. 16.

In this embodiment, the first reflector 60a and the second reflector 60b may be white walls. The upper surface of a red phosphor layer or fluorescent resin part including a red phosphor 32 is at least at the same level as or lower than the top end of the first reflector 60a. Each of the first LED chip 20 and the second LED chip 40 includes electrodes disposed on the underside thereof. The electrodes protrude downward from the lower end of each of the first reflector 60a and the second reflector 60b.

Now, features of the LED packages for backlight units applied to the foregoing embodiments will be explained below. It is noted that elements mentioned below are not denoted by reference numerals but are the same as those described above.

As explained above, each of the LED packages for backlight units is designed such that white light having an emission spectrum shown in FIG. 17 is emitted by a combination of first LED chips, a red phosphor, and second LED chips. Blue light emitted from the first LED chip and green light emitted from the second LED chip are isolated from each other in an area where the blue light excites the red phosphor. Each of the first LED chips and the second LED chips may be made of a material including a semiconductor compound represented by Al(x)Ga(y)In(1−x−y)N (0≤x≤1, 0≤y≤1, 0≤x+y≤1) and the red phosphor excited by the blue light to emit red light is advantageously Sr[LiAl₃N₄]Eu²⁺ (SLA).

Referring to FIG. 17, the peak wavelength of the blue light is in the range of 440 nm to 460 nm, the peak wavelength of the green light is in the range of 520 nm to 530 nm, and the peak wavelength of the red light is in the range of 640 nm to 650 nm. The colors of the light emitted from the first LED chips and the light emitted from the second LED chips are primary colors, respectively, which explains their small FWHM values. Despite the use of Sr[LiAl₃N₄]Eu²⁺ (SLA) as the red phosphor, the red light emitted from the phosphor has a FWHM of <60 nm. Table 1 compares the features of the red phosphor SLA used in the present invention with those of KSF as a comparative red phosphor.

TABLE 1

| | Peak | BT2020 | | |
|---|---|---|---|---|
| | wavelength | coverage | FWHM | Response time |
| SLA | 650 nm | ≥90% | Single peak, <60 nm | <1 μs |
| KSF | 630 nm | <90% | 3 narrow peaks | >10 ms |

The use of the combination of the first and second LED chips isolated from each other and the red phosphor SLA having a peak wavelength of 650 nm and a FWHM of <60 nm can provide a BT2020 coverage of ≥90%, thus achieving high color reproducibility, unlike the use of the phosphor KSF. The red phosphor is required to have a peak wavelength of at least 1440 nm to 660 nm in order to achieve a desired color gamut. The FWHM of the red light spectrum is preferably <60 nm. The phosphor SLA has a response time of <1 μs, which solves the problem of afterglow observed when the conventional red phosphor having a response time of >10 ms is used.

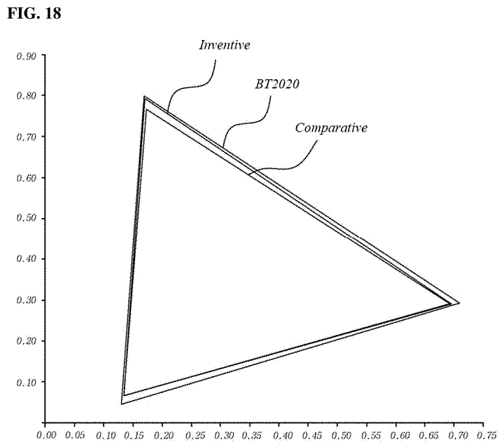

The combination of the first and second gallium nitride LED chips and the phosphor SLA leads to an increase in color gamut compared to the BT2020 color gamut. Referring particularly to FIG. 18, a wider color gamut than the BT2020 color gamut can be provided when the first LED chips and the phosphor are separated from the second LED chips in an area where the blue light emitted from the first LED chips excite the red phosphor as in the present invention, compared to when the first LED chips and the phosphor are not separated from the second LED chips in an area where the blue light emitted from the first LED chips excite the red phosphor. This inventive construction is advantageous in terms of color reproducibility as well as luminous efficiency.

What is claimed is:

1. A display device comprising: a liquid crystal panel comprising color filters; and a backlight unit comprising a light guide plate arranged in rear of the liquid crystal panel and a bar-type LED module arranged at one side of the light guide plate to supply backlight to the one side of the light guide plate, wherein the bar-type LED module comprises: a substrate elongated along the one side of the light guide plate; a plurality of LED packages arrayed on the substrate and each comprising a first LED emitting first white light and a second LED emitting second white light and separated from the first LED by a partition wall; a first wiring connecting the first LEDs of the plurality of LED packages in series; a second wiring connecting the second LEDs of the plurality of LED packages in series; and a control unit controlling the ratio of a current applied to the first LEDs and a current applied to the second LEDs to adjust the color coordinates of backlight produced by the first white light and the second white light, and wherein the control unit adjusts the color coordinates of the backlight along a straight line connecting the color coordinates of the first white light and the color coordinates of the second white light.

2. The display device according to claim 1, wherein the X and Y values of the color coordinates of the second white light are greater than those of the color coordinates of the first white light.

3. The display device according to claim 1, wherein the color coordinates of the first white light are (0.207<X<0.257, 0.160<Y<0.210) and the color coordinates of the second white light are (0.316<X<0.366, 0.313<Y<0363).

4. The display device according to claim 1, wherein each of the LED packages comprises a first cavity and a second cavity separated by the partition wall, the first LED is constructed by a combination of a first LED chip and a first phosphor located in the first cavity, and the second LED is constructed by a combination of a second LED chip and a second phosphor located in the second cavity.

5. The display device according to claim 4, wherein the first LED chips and the second LED chips are blue LED chips, the first phosphor is a yellow phosphor, and the second phosphor is a mixture of a yellow phosphor and an orange phosphor.

6. A display device comprising: a liquid crystal panel comprising color filters; and a backlight unit comprising a light guide plate arranged in rear of the liquid crystal panel and a bar-type LED module arranged at one side of the light guide plate to supply backlight to the one side of the light guide plate, wherein the bar-type LED module comprises: a substrate elongated along the one side of the light guide plate; a plurality of first packages arrayed on the substrate and emitting first white light; a plurality of second packages arrayed alternately with the first packages on the substrate and emitting second white light; a first wiring connecting the first packages in series; a second wiring connecting the second packages in series; and a control unit controlling the ratio of a current applied to the first packages and a current applied to the second packages to adjust the color coordinates of backlight produced by the first white light and the second white light, and wherein the control unit adjusts the color coordinates of the backlight along a straight line connecting the color coordinates of the first white light and the color coordinates of the second white light.

7. The display device according to claim 6, wherein the color filters secondarily adjust the color coordinates of the light that have been primarily adjusted by the backlight unit.

8. The display device according to claim 6, wherein the X and Y values of the color coordinates of the second white light are greater than those of the color coordinates of the first white light.

9. The display device according to claim 6, wherein the color coordinates of the first white light are (0.207<X<0.257, 0.160<Y<0.210) and the color coordinates of the second white light are (0.316<X<0.366, 0.313<Y<0363).

10. The display device according to claim 6, wherein when the control unit adjusts the color coordinates of the backlight, the first packages and the second packages are always turned on.

11. A display device comprising: a liquid crystal panel comprising color filters; and a backlight unit comprising a light guide plate arranged in rear of the liquid crystal panel and a bar-type LED module arranged at one side of the light guide plate to supply backlight to the one side of the light guide plate, wherein the display device comprises: a wavelength converting sheet arranged between the bar-type LED module and the liquid crystal panel; a substrate elongated along the one side of the light guide plate; a plurality of LED packages arrayed on the substrate and each comprising a first LED cooperating with the wavelength converting sheet to emit first white light and a second LED cooperating with the wavelength converting sheet to emit second white light and separated from the first LED by a partition wall; a first wiring connecting the first LEDs of the plurality of LED packages in series; a second wiring connecting the second LEDs of the plurality of LED packages in series; and a control unit controlling the ratio of a current applied to the first LEDs and a current applied to the second LEDs to adjust the color coordinates of backlight produced by the first white light and the second white light, and wherein the color coordinates of the backlight are adjusted along a straight line connecting the color coordinates of the first white light and the color coordinates of the second white light.

12. The display device according to claim 11, wherein the color filters secondarily adjust the color coordinates of the light that have been primarily adjusted by the backlight unit.

13. The display device according to claim 11, wherein the X and Y values of the color coordinates of the second white light are greater than those of the color coordinates of the first white light.

14. The display device according to claim 11, wherein the first LEDs are blue LEDs and the second LEDs are white LEDs.

15. The display device according to claim 11, wherein the wavelength converting sheet comprises quantum dots.

16. A display device comprising: a liquid crystal panel comprising color filters; and a backlight unit comprising a light guide plate arranged in rear of the liquid crystal panel and a bar-type LED module arranged at one side of the light guide plate to supply backlight to the one side of the light guide plate, wherein the display device comprises: a wavelength converting sheet arranged between the bar-type LED module and the liquid crystal panel; a substrate elongated along the one side of the light guide plate; a plurality of first packages arrayed on the substrate and cooperating with the wavelength converting sheet to emit first white light; a plurality of second packages arrayed alternately with the first packages on the substrate and cooperating with the wavelength converting sheet to emit second white light; a first wiring connecting the first packages in series; a second wiring connecting the second packages in series; and a control unit controlling the ratio of a current applied to the first packages and a current applied to the second packages to adjust the color coordinates of backlight produced by the first white light and the second white light, and wherein the color coordinates of the backlight are adjusted along a straight line connecting the color coordinates of the first white light and the color coordinates of the second white light.

17. The display device according to claim 16, wherein the color filters secondarily adjust the color coordinates of the light that have been primarily adjusted by the backlight unit.

18. The display device according to claim 16, wherein the first packages are blue LEDs and the second packages are white LEDs.

19. The display device according to claim 16, wherein the wavelength converting sheet comprises quantum dots.

20. The display device according to claim 16, wherein the color coordinates of the first white light are (0.207<X<0.257, 0.160<Y<0.210) and the color coordinates of the second white light are (0.316<X<0.366, 0.313<Y<0363).
